(19) United States
(12) Patent Application Publication
(10) Pub. No.: US 2002/0198750 A1
(43) Pub. Date: Dec. 26, 2002

(54) Risk management application and method

(76) Inventors: Bruce Donald Innes, West Chester, OH (US); Gregg Hunt Wilson, Cincinnati, OH (US); Hugh Michael Walsh, Cincinnati, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/886,362

(22) Filed: Jun. 21, 2001

(51) Int. Cl. G06F 17/60

(52) U.S. Cl. 705/7

(57) ABSTRACT

A risk management application permits users to create and store their project's risks and abatements. The risk management application is available over an organization-wide network such as an Intranet or Extranet and is accessed from a common starting point using a web browser. All the information entered by a user into the risk management application is stored in a common database that can be accessed by all users. The risk management application can also be used to generate standardized reports, plots and scorecards on risk management for an individual project or a series of projects. Finally, the risk management application has features that assist a user in entering information such as automatic entry of previously entered information and auditing capabilities to check if all required information has been entered by the user.

### BACKGROUND OF THE INVENTION

The present invention relates generally to risk assessments for projects. More specifically, the present invention relates to an application and method for identifying and analyzing risks for an engineering project.

In most engineering projects, a risk analysis is usually completed for the project. The risk analysis permits the engineering team working on the engineering project to identify and evaluate the potential problems or risks that are associated with that engineering project. As the complexity and quality requirements on an engineering project are increased, the corresponding risk analysis that is completed for that project also becomes more complex and difficult. In addition, if any engineering work on the project is transferred to an outside source, additional risk factors relating to quality control and policy compliance by the outside source are introduced into the risk analysis.

Typically, the risk analysis or assessment that is completed for an engineering project is dependent on the type of engineering project. The risk analysis is often completed using a spreadsheet or database program to simplify and provide some standardization to the risk analysis process. Even in large companies or organizations that have a standard written risk assessment procedure, different groups in the company often make custom modifications to the standard procedure to accommodate the particular type of engineering project worked on by the group. In other words, even where there is standard written risk assessment procedure for a company, each group in the company may have its own customized risk assessment procedure implemented in a particular software package for the engineering projects of the group.

The use of different risk assessment procedures and different software packages by each group in a company can make it difficult to compare and interpret the completed risk assessments because a risk and its corresponding analysis may have different meanings for different types of projects. In addition, the completed risk assessment procedures are stored in a format and location that is specific to a particular group. Thus, the completed risk assessment procedures are not stored in a central location and in a common format accessible by all the groups. The lack of a common location and format can make it difficult to retrieve and recreate risk assessments for comparisons, to resolve disputes or to gain lessons learned knowledge from previous risk assessments completed on other projects.

Therefore, what is needed is a management application to implement an approved risk process for engineering projects that can be used by all users of an organization or company to analyze, display, monitor and store the risks assessments for an engineering project in a consistent manner.

### SUMMARY OF THE INVENTION

One embodiment of the present invention is directed to a method of managing risks associated with a project and a computer program product implementing the method. The method includes the steps of defining impact criteria for all risks of a project and identifying a plurality of risks associated with the project. The method also includes storing risk information on at least one risk in a database, assessing at least one risk using the defined impact criteria and preparing at least one abatement for at least one risk. The method further includes storing abatement information on the at least one abatement in the database. Finally, the method includes monitoring the plurality of risks associated with a project over the life of the project, updating the risk information and the abatement information in the database and repeating the steps of monitoring the plurality of risks and updating the risk information and the abatement information in the database until each risk of the plurality of risks is indicated as finished.

Another embodiment of the present invention is directed to a system for analyzing and managing risks associated with a project. The system includes a server computer having a storage device and a processor. The system further includes a risk management application to analyze and manage risks associated with a project. The risk management application is stored in the storage device of the server computer. The risk management application includes a database to store information relating to the project. The application also includes means for providing risk impact criteria for all risks of the project, which risk impact criteria is stored in the database, means for providing risk information for at least one risk, which risk information is stored in the database and means for providing abatement information for at least one risk, which abatement information is stored in the database. The application further includes means for providing an assessment of at least one risk, which assessment of at least one risk is based the risk impact criteria and means for calculating a risk score for the assessed at least one risk, which risk score is based on the assessment. The application has means for generating a project report, which project report includes the risk information and the abatement information stored in the database and means for updating the risk information and the abatement information in the database. The updating of the risk information and abatement information can be based on information derived from field experiences. Finally, the system includes at least one client computer in communication with said server computer and the risk management application is accessible on the at least one client computer.

One advantage of the present invention is that all groups in a company or organization can access and use a common risk assessment user interface, report format, and risk scorecard, which improves the interpretation of the reports and assessment by the personnel who receive a risk assessment.

Another advantage of the present invention is that engineering productivity is increased by reducing the cycle time to create project risk assessments and to generate risk scorecards and reports. Reports and scorecards can be generated and displayed automatically providing a significant manpower and cost savings over the previous practice of generating the reports manually with a team of engineers.

Still another advantage of the present invention is that all projects' risks and abatements are stored in a common database for easy retrieval, review and revision by appropriate users.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a flowchart illustrating a basic risk assessment process.

FIG. 2 illustrates a project selection web page.

FIG. 3 illustrates a project information entry web page.

FIG. 4 illustrates a project risk assessment starting web page.

FIG. 5 illustrates a risk management web page.

FIG. 6 illustrates a risk template web page.

FIG. 7 illustrates a risk impact criteria web page.

FIG. 8 illustrates a new risk entry web page.

FIG. 9 illustrates a risk summary web page.

FIG. 10 illustrates a risk abatement entry web page.

FIG. 11 illustrates a risk abatement update web page.

FIG. 12 illustrates a risk report web page.

FIG. 13 illustrates a risk abatement plan web page.

Whenever possible, the same reference numbers will be used throughout the figures to refer to the same parts.

### DETAILED DESCRIPTION OF THE INVENTION

The present invention is directed to an application for assisting a user with the management and analysis of risks on a project. Preferably, the risk management application is used by engineers for the management and analysis of risks associated with an engineering project. However, the present invention can be used with any type of project that has associated risks and requires management and analysis of those risks. The risk management application is used by the engineers to define the risk impact criteria for a project and then to identify and categorize risks (using a risk scoring technique) based on the defined risk impact criteria. In addition, the risk management application is used to prepare abatement plans for implementation for the risks and then to update and monitor the status of the risks and the implemented abatement plans as work is started and subsequently completed on the engineering project by the engineers.

In another embodiment of the present invention, the risk management application can be incorporated as a component of a larger application that is executed within the larger application. The risk management application can again be used to perform risk analysis and management, however, the risk analysis and management is now included as a portion of the larger application. The risk management application's use and formatting of risk and abatement information is accomplished in a manner that can be interpreted and understood by the larger application. The larger application can then retrieve and use the risk and abatement information from the risk management application in other operations of the larger application. For example, the larger application may incorporate risk information into a report or scorecard that is generated by the larger application.

In a preferred embodiment of the present invention, the risk management application is implemented as a network application that is executed in a web browser of the user or engineer. The risk management application can be executed on the client-side, the server-side or on both the client-side and the server-side. Preferably, the risk management application is stored on the server computer and then accessed by the users on the client computers. The risk management application also has one or more databases that are used to store risk and abatement information. The risk information databases are also preferably stored on the server computer and accessed by the users on client computers. In another embodiment, each client computer on the computer network may store an individual copy of the risk management application and the risk information databases for the risk management application can be stored on either a server computer or one or more of the client computers.

The computer network is preferably the Intranet, however any other type of network can also be used, for example, an Internet, a local area network (LAN), a wide area network (WAN) or an Extranet. The client computer and server computer can be any type of general purpose computer having memory or storage devices (e.g. RAM, ROM, hard disk, CD-ROM, etc.), processing units (e.g. CPU, ALU, etc.) and input/output devices (e.g. monitor, keyboard, mouse, printer, etc.). The general purpose computer may also have communication devices (e.g. modems, network cards, etc.) for connecting or linking the general purpose computer to other computers.

In another embodiment of the present invention, the risk management application can be executed without any requirement for a network connection. The risk management application can be executed from an internal memory or storage device, e.g. RAM, ROM, hard disk, etc., of the computer of the user in either a web browser as discussed above or in an operating system environment, such as a Windows environment, a Linux environment or a Unix environment. The risk management application can be loaded into the internal memory of the user's computer from a portable medium such as a CD-ROM, DVD-ROM, floppy disk, etc., that is inserted into the computer. Alternatively, the risk management application can be transferred or loaded directly into the internal memory of the user's computer through an electronic connection with another computer that has a stored copy of the risk management application. In other words, the risk management application can be downloaded to the user's computer from another computer over a network connection or an Internet connection and then be operated without the network connection. The user is able to use the risk management application without a network connection and is able to store risk information in a database, however, for other users to be able to have access to the risk information, the user has to reestablish a network connection and upload any risk information into the common database that can be accessed by all users.

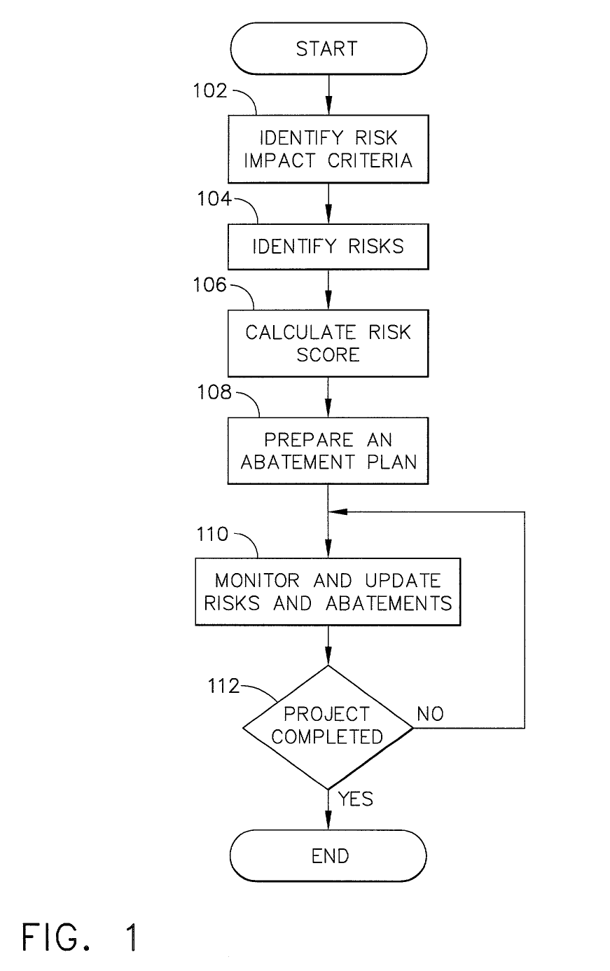

The risk management application is used for the management and analysis of risks on a project. FIG. 1 illustrates the steps of performing a risk assessment for a project that can be completed using the risk management application. To begin, in step 102 the risk impact criteria for the project is identified. The risk impact criteria is used as the basis for the rating and evaluating of the risks of the project. Preferably, the risk impact criteria defines high, medium and low risks for matters relating to technical issues, scheduling issues and cost issues. Risk impact criteria can also be defined for matters relating to other types of issues than the ones described above.

Next, in step 104 the risks for the project are identified and the identified risks are scored and categorized in step 106. The identification of risks in step 104 is conducted by a project team or engineering team working on the project. The project team identifies the potential risks for the project from the cost, schedule and technical point of view. In addition, the project team also generates ideas or actions for overcoming the risks. The identified risks are then assembled into a consolidated list that includes each risk and any corresponding action for the risk. In step 106, the identified risks are assigned a risk rating that incorporates a risk probability for the risk and an impact determination (high, medium, or low) for each of the technical issues, scheduling issues and cost issues of the risk impact criteria for the risk. The total risk score is calculated by multiplying the risk probability by the sum of the impact determinations for the technical issues, scheduling issues and cost issues. A maximum risk score is calculated by multiplying the risk probability by the maximum of the impact determinations of the technical issues, scheduling issues and cost issues. In addition, a user or engineer can designate a particular risk as a critical risk for the project.

In step 108, the project team can prepare for implementation an abatement plan for each of the identified and scored risks using the ideas or actions for overcoming the risks identified in step 104. Preferably, an abatement plan for the highest rated or scored risks is prepared before an abatement plan is prepared for the lower scored risks (if an abatement plan is even prepared for the lower scored risks). In the abatement plan, the user can enter additional details on the actions, the estimated risk impact determinations after the abatement plan has been completed and an estimated completion date for the abatement plan. In addition, multiple abatement actions can be prepared and incorporated into an abatement plan for a single risk. If there are multiple abatement actions assigned to a particular risk, then one or more of the abatement actions can be given a secondary abatement designation. The secondary abatement designation identifies an abatement that is not to be included in any reports or scorecards for the risk and is only to be stored as a potential abatement for the risk.

In step 110, the user or engineer monitors and updates the risks and their associated abatement plans. Then, in step 112, the user or engineer checks to see if all of the identified risks of the project are closed or completed, i.e. the abatement plan for each of the risks has been completed. If all the identified risks of the project are closed, then the risk analysis and management process for the project has been completed by the user or engineer. Otherwise, the monitoring and updating of the risks and the abatement plans in step 110 is repeated until all risks are closed. The ability to update the risks and the abatement plans for the risks is important in controlling the risks of the project by permitting the user or engineer to update the risks and abatement plans in response to actual events and situations that are occurring as work on the project is being completed. The user has the ability to update the status of the risk based on a periodic review of the risk and the abatement plan as well as on actual data received from the field. Once all of the abatement items in the abatement plan are completed, the risk can be tagged as closed by the user.

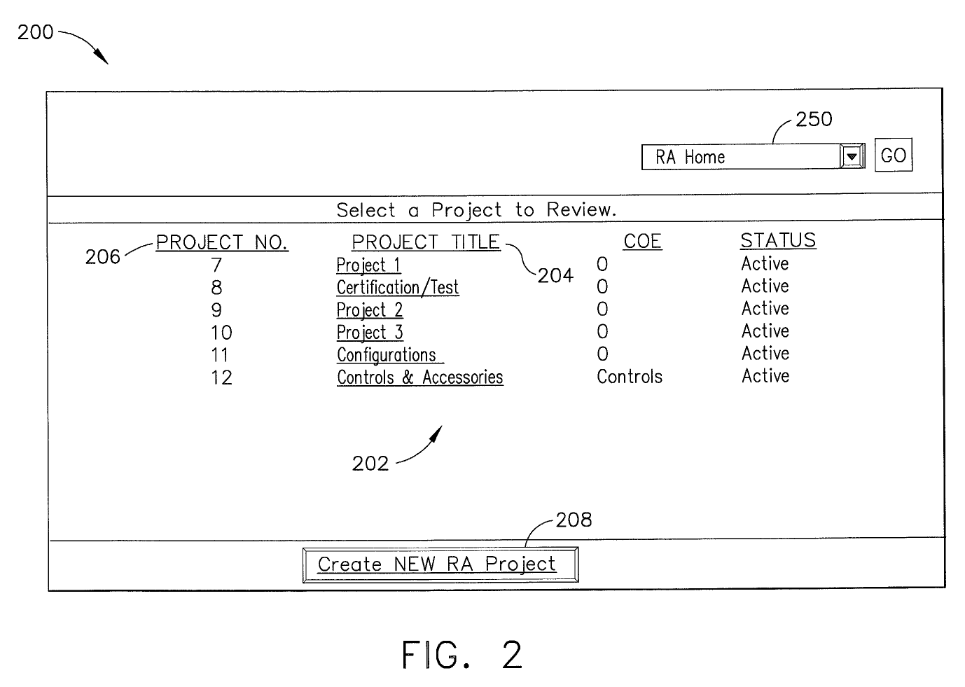

In a preferred embodiment of the present invention, a user can use the risk management application to complete the risk assessment process shown in FIG. 1. The risk management application is preferably an Intranet application executed within a web browser that can be accessed by any user that has access to the Intranet. To use the risk management application, a user has to first access a starting page or home page for the risk management application with a web browser. The user then has to select a project that requires the risk management and analysis operations of the risk management application. FIG. 2 illustrates a project selection web page 200 from the risk management application that can be displayed within a web browser.

The project selection web page 200 displays a list 202 of projects that can be accessed by the user. The project list 202 includes information on the projects for the user. The project list 202 includes a project title 204 and a project number 206 for each project included in the project list 202. The project title 204 and the project number 206 can be used to uniquely identify each project that is accessible using the risk management application. The project list 202 can also include other information on projects such as project status and a project category. If the project list 202 does not include the particular project of interest to the user, the user can create a new project for risk assessment and management by selecting command 208 located on the project selection web page 200. In one embodiment of the present invention, the ability of user to create new projects can be restricted to only certain predetermined users having the designated authority to create new projects.

In addition, the project selection web page 200 can include an option 250 to select and access a particular web page of the risk management application or other web pages. The web page selection option 250 is preferably a drop-down box or menu, however, any suitable selection mechanism can be used for the user to select a web page. The web page selection option 250 permits a user to quickly access a particular web page of the risk management application. Some of the web pages that can be accessed with the web page selection option are the project selection web page 200, a home web page, a scorecard web page, a new project web page or any other type of web page that is accessible from the risk management application. In addition, web pages can also be accessed from the Internet or an Extranet. In a preferred embodiment of the present invention, the majority of the web pages accessed and displayed by the risk management application include the web page selection option 250.

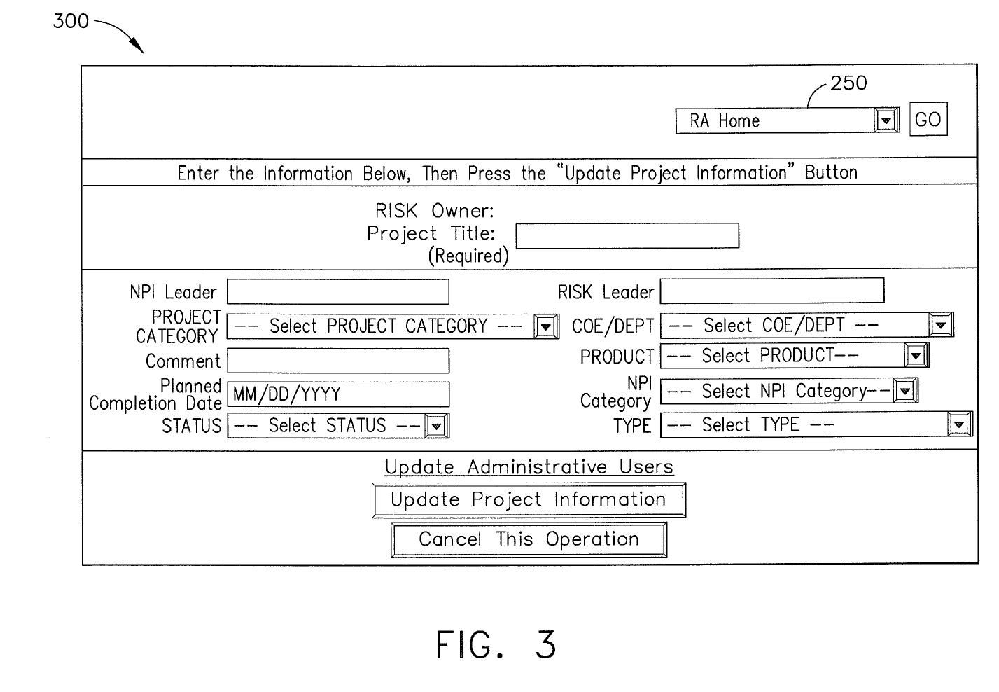

If a user selects the new project command 208, the user is requested to enter some initial information about the project. FIG. 3 illustrates project information entry web page 300 from the risk management application that can be displayed within a web browser. Upon initial creation of the project the user is required to enter a project title 204 for the new project into the project information entry web page 300. The user can also enter additional information on the new project with the project information entry web page 300. The additional information on the project that can be entered in project information entry web page 300 can be of any type and can include information such as a project category, a project status, project leaders or the item or product that is undergoing the risk assessment. After the user has entered the project title 204 and any other additional information, the user submits this information to the risk management application, which in turn assigns a project number 206 to the project and stores the project information in a database of the risk management application under that project number 206. The user is not required to enter all of the additional information that may be requested on project information entry web page 300 and can return to the project information entry web page 300 at a later time. The user can update the project information that is stored in the database for the project by accessing the project information entry web page 300 and adding, deleting or editing the project information requested by the project information entry web page 300 and stored in the database. Preferably, the risk management application has one or more central databases to store the project information for subsequent access by other users of the risk management application.

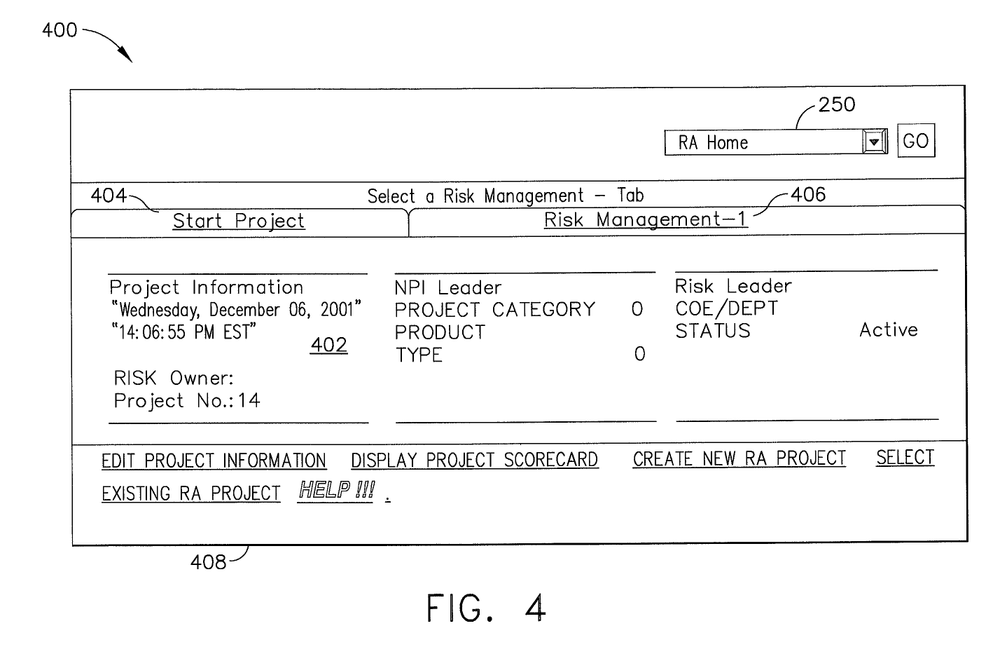

After the user has entered the new project information into project information entry web page 300, the user can then begin the risk assessment and management process for the project. FIG. 4 illustrates a project risk assessment starting web page 400 from the risk management application that can be displayed within a web browser. In the project risk assessment starting web page 400, the user is presented with a display field 402 having general project information from the database that was entered using the project information entry web page 300. From the project risk assessment starting web page 400, the user can select from a variety of different options. The user can select the Start Project Option 404 to return to the project information entry page 300 to add or edit the project information. In addition, the user can select from other options 408, which other options 408 can include the ability to edit the project information, to display a project scorecard, to start a new project, to jump to a different project or to obtain help information. Finally, to begin or continue the risk management and assessment process the user can select the risk management option 406.

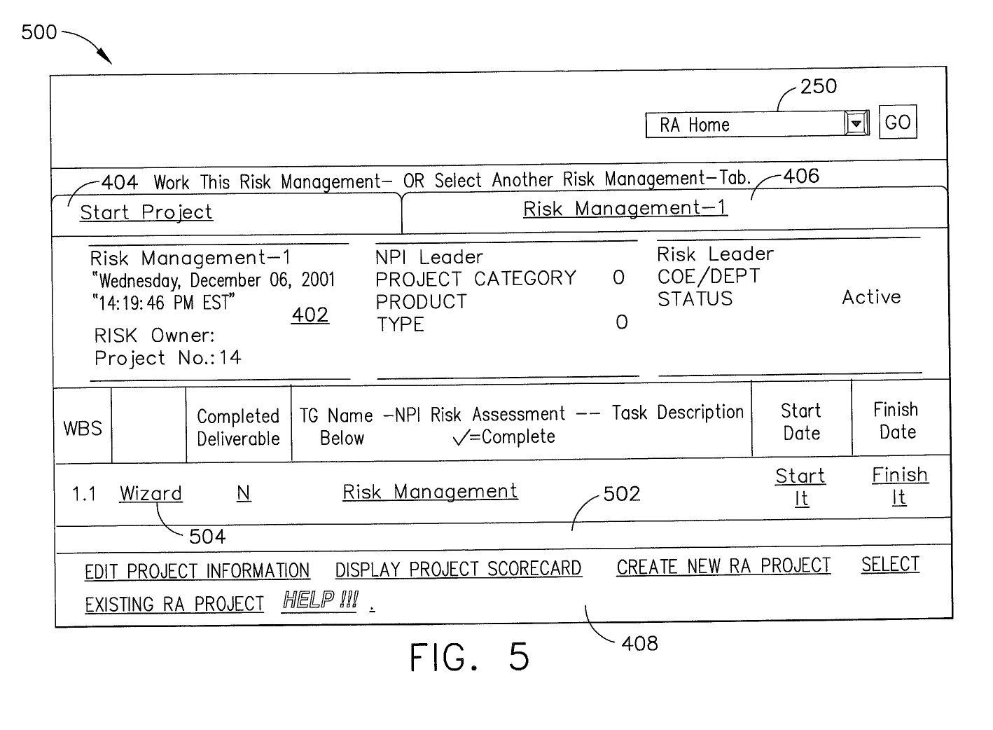

After the user has selected the risk management option 406, the user can begin the steps of the risk management process. FIG. 5 illustrates a risk management web page 500 from the risk management application that can be displayed within a web browser. The risk management web page 500 includes the steps 502 of the risk management process. It is to be understood that while only one risk management step 502 is displayed in the risk management web page 500 of FIG. 5, there can be any number of risk management steps 502 of the risk management process displayed by the risk management web page 500. The risk management steps 502 include information on the steps of the risk management process and include fields where the user can enter information about the step, such as a start date or finish date. In addition, the user can access an additional program or wizard 504 that can provide the user with further assistance in completing the step of the risk management process.

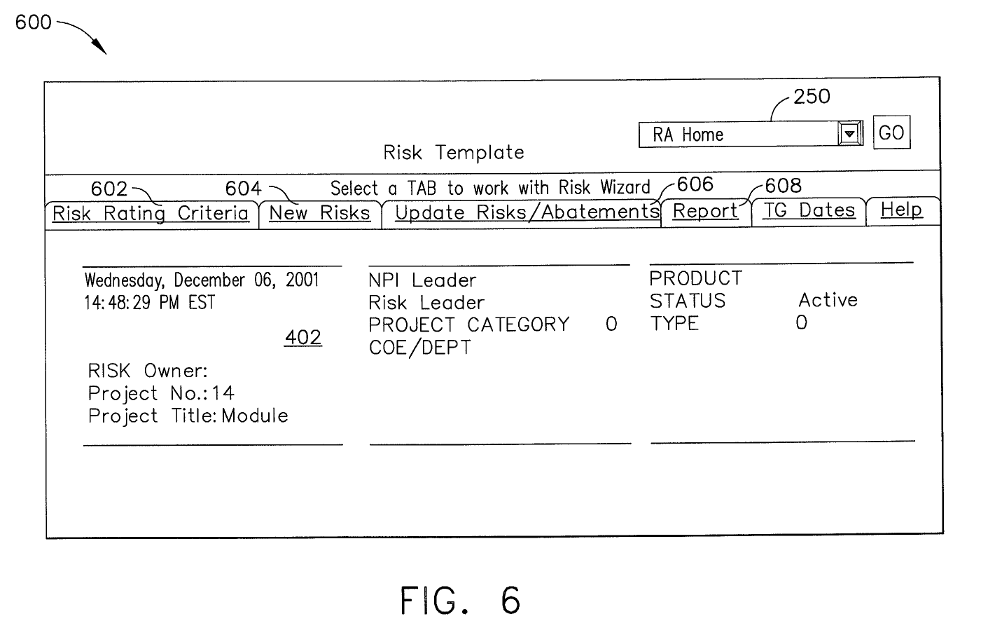

The selection of the wizard 504 by the user can provide the user with several different options or utilities associated with the risk assessment process. FIG. 6 illustrates a risk template web page 600 from the risk management application that can be displayed within a web browser. The risk template web page 600 provides the user with assistance in recognizing and completing several different aspects of the risk assessment process. In another embodiment of the present invention, the user can directly access the risk template web page 600 by selecting the risk management option 406 without having to select the risk management wizard 504.

The risk wizard template web page 600 includes the display field 402 that provides the user with general project information and may include the other options 408, which are not shown in FIG. 6. In the risk template web page 600, the user can select from a variety of different options relating to the risk management process. The user can select a risk rating criteria option 602 to define and revise the risk impact criteria for the project. The user can also select a new risk option 604 to define new risks for the project. In addition, the user can select an update risks and abatements option 606 to update and revise information relating to the risks and abatements of the project. Furthermore, the user can select a reports option 608 to automatically generate a variety of different types of reports using project information from the database. Finally, the user can select from other options such as an option to assign tollgate dates to the project or an option to obtain help information or any other similar type of option.

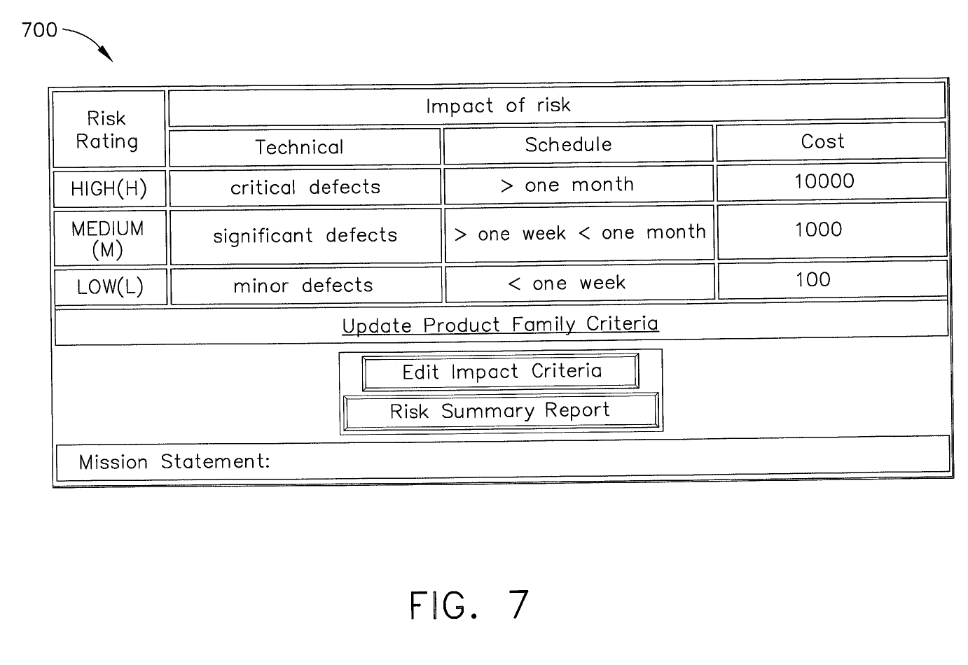

The selection of the risk rating criteria option 602 by the user permits the user to define and revise the risk impact criteria for the project. FIG. 7 illustrates a risk impact criteria web page 700 from the risk management application that can be displayed within a web browser. In another embodiment of the present invention, the information and table included in the risk impact criteria web page 700 can be incorporated and displayed in the risk template web page 600. The risk impact criteria web page 700 initially has predetermined risk impact criteria that is derived from risk impact criteria for a corresponding product family of the product type that is the focus of the project. If there is no risk impact criteria for the product family or if the user has not entered a product type, then a default risk impact criteria applicable to all types of projects is provided in the risk impact criteria web page 700. The user can revise and edit the default or predetermined risk impact criteria for the project to specifically customize the risk impact criteria to the specifics of the project and then save the risk impact criteria for the project in the project database.

Preferably, the user can only edit and revise the risk impact criteria for the particular project being worked on by the user. However, depending on the user's authorization, the user can redefine the risk impact criteria for the entire product family by selecting an option on the risk impact criteria web page 700. The authorized user can then access a product family risk impact criteria web page, which is similar to the risk impact criteria web page 700. From the product family risk impact criteria web page, the authorized user can edit and modify the risk impact criteria for the entire product family. The revised product family risk impact criteria is then used for each subsequent project that has a product within that corresponding product family.

Each different type of product family can have its own particular risk impact criteria. The risk impact criteria for a product family is initially defined by an authorized user by accessing a product family risk impact criteria web page. To initially define the risk impact criteria for a product family the user either starts with the default risk impact criteria or with no risk impact criteria at all. If the default risk impact criteria is used, the authorized user has to update only specific criteria of the risk impact criteria to customize the default risk impact criteria to the product family. Otherwise, the authorized user has to define the entire risk impact criteria for the particular product family. The authorized user, after entering the risk impact criteria for the product family, stores the product family risk impact criteria in a database so that subsequent users can select the product family risk impact criteria for use on their particular project.

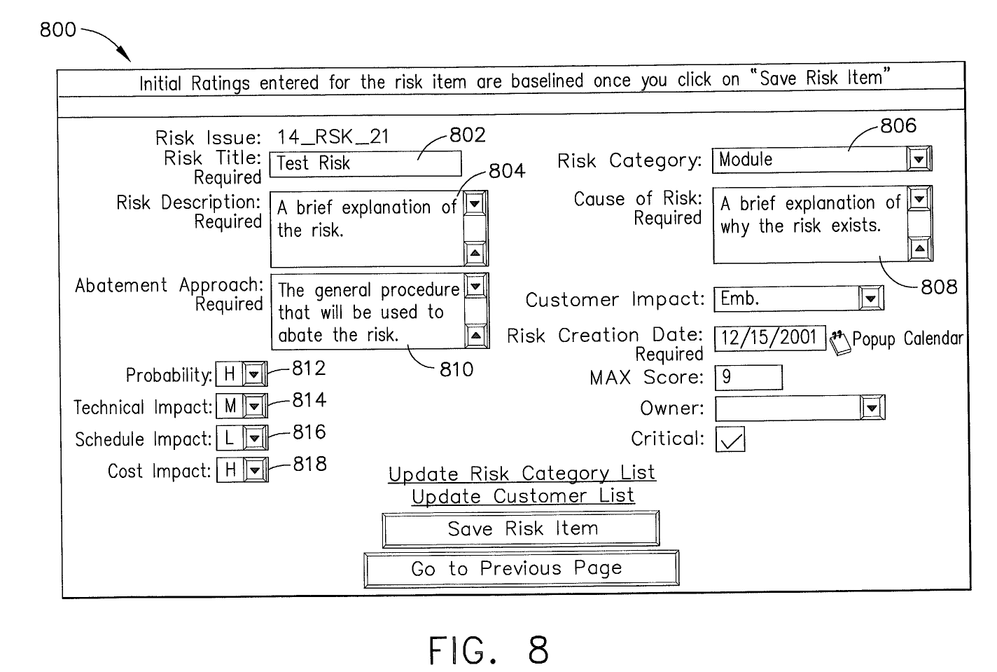

The selection of the new risks option 604 by the user permits the user to enter information on a new risk for the project. FIG. 8 illustrates a new risk entry web page 800 from the risk management application that can be displayed within a web browser. In another embodiment of the present invention, the information and entry fields included in the new risk entry web page 800 can be incorporated and displayed in the risk template web page 600. In the new risk entry web page 800, the user can enter information on the risk using risk information entry fields 802-810. The user can enter a title for the risk in field 802, a description of the risk in field 804, a category for the risk in field 806, a cause of the risk in field 808, an abatement approach for the risk in field 810 or any other similar type of information relating to the risk. The user can also assign a rating for the risk using rating entry fields 812-818. The user can enter a rating for risk probability in field 812, a rating for technical impact of the risk in field 814, a rating for schedule impact of the risk in field 814, a rating for cost impact of the risk in field 816 or any other similar type of rating for the risk. The ratings for the risk can be based a high, medium or low scale, can be based on a numeric value, e.g. 1-10, or any other suitable rating system. Once the ratings have been entered for the risk, the risk management application can automatically calculate a total risk score and a maximum risk score for the risk. The user can also identify the risk as being a critical risk on new risk entry web page 800.

After the user has entered the risk information into the new risk entry web page 800, the user can store the risk information for the project in the database. When the user stores the information from the new risk entry web page 800, the risk is assigned a unique identification (ID) number and all information relating to that risk is then identified using that unique ID number.

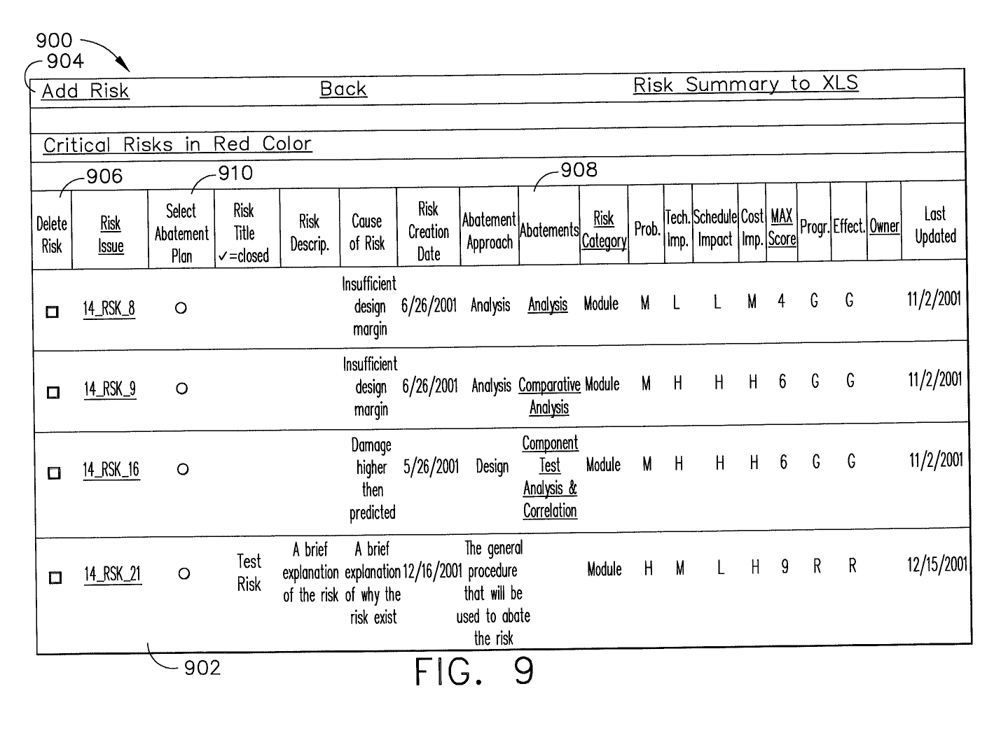

The selection of the update risks and abatements option 604 by the user permits the user to review a risk and abatement summary table for the project. FIG. 9 illustrates a risk summary web page 900 from the risk management application that can be displayed within a web browser. In another embodiment of the present invention, the information, table and options included in the risk summary web page 900 can be incorporated and displayed in the risk template web page 600. The risk summary web page 900 includes a table or listing 902 of all the risks for the project and risk information that was entered for each of the risks. The risk table 902 can include the following types of information on each of the risks of the project: the unique risk ID number; the risk title; the risk description; the cause of the risk; the abatement approach; the risk category; the risk probability rating; the risk technical impact rating; the risk schedule impact rating; the risk cost impact rating; the maximum risk score; the total risk score; and the risk owner. The user can also sort the information in the risk table 902 based on entries in a particular column of the risk table. For example, the user can sort the risk table based on the risk ID number, the maximum risk score, the risk category, etc. In addition, it is to be understood that any information on the risks of the project stored in the database can be displayed in the risk table 902 and that the particular selection and arrangement of information included in the risk table 902 can be varied depending on the requirements of the user.

In the risk summary web page 900, the user can select an option and return to the new risk entry web page 800 to enter and revise risk information relating to an existing risk. Any changes made to the risk information of the risk are stored in the database and subsequently reflected in the risk table 902. In a preferred embodiment, the user can select a link embedded into the risk ID for the risk in the risk table 902, however, any suitable means for reaccessing the new risk entry web page 800 can be used to enter and revise information for a risk. The user can add a new risk by selecting an option 904 that transfers the user to the new risk entry web page 800 for the entry of information on the new risk. The user can also remove a risk by selecting a delete risk option 906 in the risk table 902.

The risk table 902 can include an abatements column 908 that displays information on the abatements that have been developed and implemented for the risk. If there are no abatements for the risk in abatement column 908 then the user can prepare an abatement for the risk by selecting an add abatement option 910 in the risk table 902. The user can also add an additional abatement to the abatement plan of the risk by selecting the add abatement option 910.

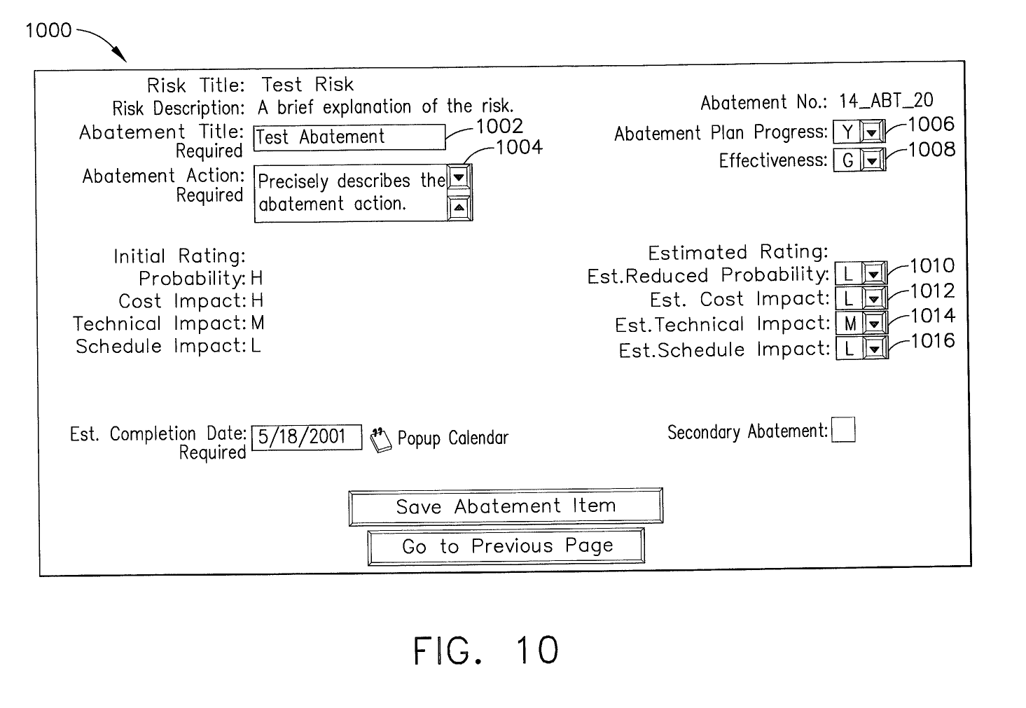

The selection of the add abatement option 910 by the user permits the user to enter information on an abatement plan for a risk of the project. FIG. 10 illustrates a risk abatement entry web page 1000 from the risk management application that can be displayed within a web browser. In another embodiment of the present invention, the information and entry fields included in the risk abatement entry web page 1000 can be incorporated and displayed in the risk template web page 600. In the risk abatement entry web page 1000, the user can enter information on the abatement plan using abatement information entry fields 1002-1008. The user can enter a title for the abatement in field 1002, an action plan for the abatement in field 1004, progress of the abatement in field 1006, an effectiveness of the abatement in field 1008, or any other similar type of information relating to the abatement. The abatement progress and effectiveness are assigned ratings to show whether or not the planned abatement is working to reduce a risk's rating. The user can also assign an estimated rating on the effect of completion of the abatement on the risk using rating entry fields 1010-1016. The user can enter a rating for an estimated reduced risk probability in field 1010, a rating for estimated technical impact of the risk in field 1014, a rating for estimated schedule impact of the risk in 1016, a rating for estimated cost impact of the risk in field 1012 or any other similar type of rating for the risk. Preferably, the estimated ratings entered for the abatement are for the same types as the initial ratings for the risk that were previously entered in new risk entry web page 800. The risk abatement entry web page 1000 can also include some information from the database on the particular risk related to the abatement. The user can also identify the abatement as being a secondary abatement on risk abatement entry web page 1000. After the user has entered the abatement information into the risk abatement entry web page 1000, the user can store the abatement information in the database for the project. When the user stores the information from the risk abatement entry web page 1000, the abatement is assigned a unique identification (ID) number and all information relating to that abatement is then identified using that unique ID number.

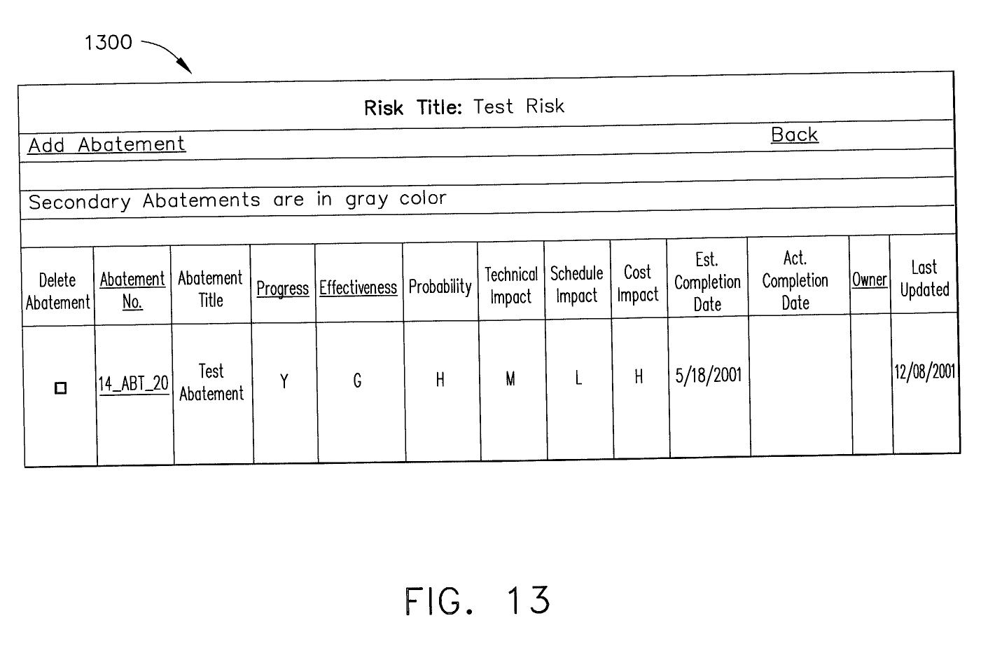

Once the user has entered information on an abatement for a risk using the risk abatement entry web page 1000, the abatement for the risk is then displayed in abatement column 908 of the risk table 902. To obtain additional information on the abatements in abatement column 908, the user can select a link embedded in the identifiers for the abatements in abatement column 908 to access an abatement plan web page. FIG. 13 illustrates an abatement plan web page 1300 from the risk management application that can be displayed within a web browser. The abatement plan web page 1300 displays information on all the abatements for a particular risk. In addition, a user can add and delete abatements from the abatement plan for the risk. As work on the project is completed, the user can update information on an abatement from the abatement plan web page 1300 by selecting an update abatement option. In a preferred embodiment, to update an abatement, the user can select a link embedded in the abatement ID number for the particular abatement that is included in abatement plan web page 1300, however, any suitable means of selecting a command or option can be used to enter and revise information for an abatement.

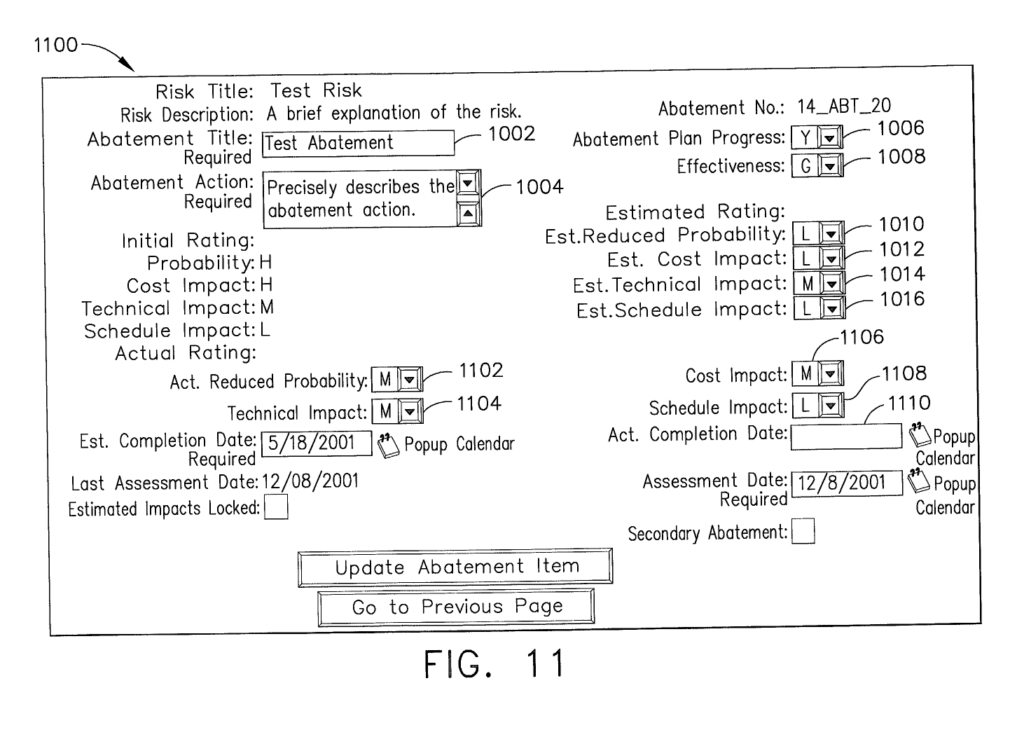

The selection of the command to update an abatement plan by the user permits the user to revise abatement information on a risk of the project. FIG. 11 illustrates a risk abatement update web page 1100 from the risk management application that can be displayed within a web browser. In another embodiment of the present invention, the information and entry fields included in the risk abatement update web page 1100 can be incorporated and displayed in the risk template web page 600. The risk abatement update web page 1100 permits a user to enter or revise information in fields 1002-1016 from the risk abatement entry web page 1000. In addition, the user can also assign an actual rating for the risk that has an implemented abatement using rating entry fields 1102-1108. The user can enter an actual rating for a reduced risk probability in field 1102, an actual rating of the abatement on the technical impact of the risk in field 1104, an actual rating of the abatement on schedule impact of the risk in field 1108, an actual rating of the abatement on the cost impact of the risk in field 1106 or any other similar type of rating for the risk. Preferably, the actual ratings entered for the abatement are of the same types as the initial ratings for the risk that were entered in new risk entry web page 800 and the estimated ratings for the risk that were entered in the risk abatement entry page 1000. The risk abatement update web page 1100 can also include some information from the database on the particular risk related to the abatement. To close or complete the abatement for the risk the user can enter in the completion date in field 1110. In addition, the user can enter other information on the success of an abatement plan in risk abatement update web page 1100. After the user has entered or revised information in the risk abatement update web page 1100, the information is again stored in the database.

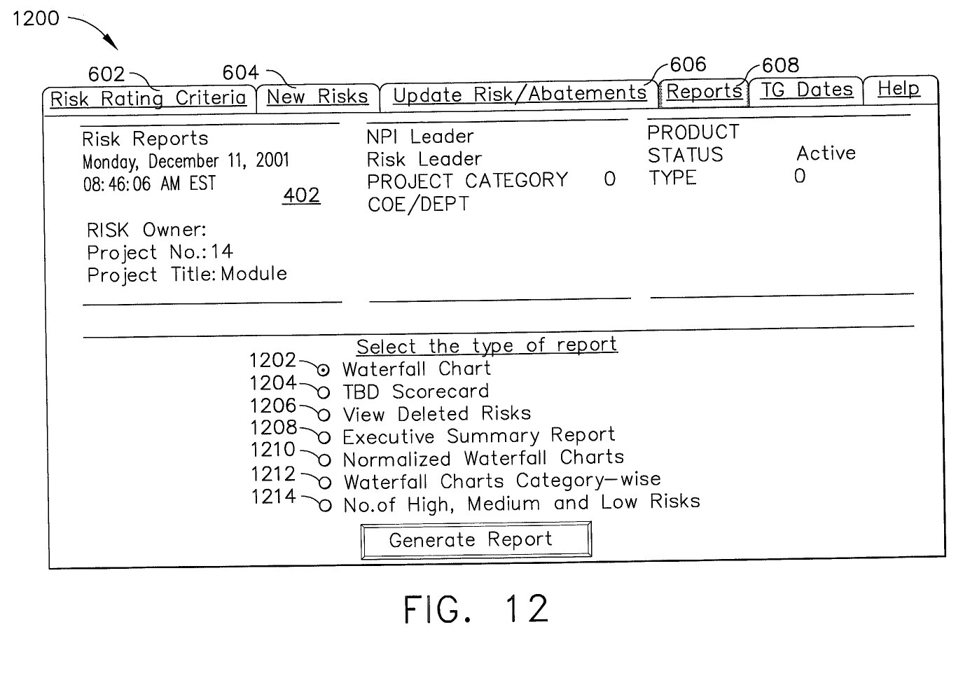

The selection of the reports option 608 by the user permits the user to generate a variety of different types of reports on the project. FIG. 12 illustrates a risk report web page 1200 from the risk management application that can be displayed within a web browser. In another embodiment of the present invention, the information and options included in the risk report web page 1200 can be displayed in a separate web page without information from the risk template web page 600. The risk report web page provides the user with several different options 1202-1214 to assemble and display information on the risks and abatements for a project. The user can view a waterfall chart by selecting option 1202, a TBD scorecard by selecting option 1204, any deleted risks by selecting option 1206, an executive summary report by selecting option 1208, a normalized waterfall chart by selecting option 1210, a waterfall chart for a category of risks by selecting option 1212 and a list of high, medium and low risks by selecting option 1214. However, it is to be understood that any type of report that may be generated with the information on the risks and abatements in the database can be included as an option on risk report web page 1200.

In another embodiment of the present invention, the risk report web page 1200 can be accessed directly by selecting a scorecards or reports web page from the web page selection option 250 on the risk template web page 600. The risk report web page 1200 can be used to generate and display reports using the information for a particular project. Additionally, if the user selects the scorecards or reports web page from the web page selection option 250 on the project selection web page 200, the user again accesses the risk report web page 1200. However, the user can obtain reports on the information for all projects instead of reports on information in a single project.

The user can generate a waterfall chart to display the sum of all risk ratings for a project by selecting waterfall report option 1202. The user can generate a waterfall chart to display the sum of all risk ratings for a project divided by the total number of risks in the project by selecting normalized waterfall chart option 1210. The user can generate a waterfall chart to display the sum of all risk ratings for all the risks in a particular category by selecting category waterfall charts option 1212. For all of the above types of waterfall charts, the user can set several different parameters that control the appearance of the report or chart. The user can select between the maximum risk score and the total risk score for a risk to display in the waterfall chart. The user can also define the starting date, ending date and interval for the waterfall chart. In addition, there can be other parameters that the user can control that determine the appearance of the waterfall chart.

In another embodiment of the present invention, the risk management application can be used to assign tollgate dates to a project. If there are tollgate dates assigned to a project, those assigned tollgate dates can be incorporated and displayed in the waterfall chart.

By selecting the TBD scorecard option 1204 the user can display a scorecard that includes of all “To Be Determined” (TBD) fields for a project. The TBD scorecard option 1204 also gives the user the option to limit the TBDs in the scorecard to only those TBDs in one or more particular fields, such as risk description field 804, risk cause field 808, abatement approach field 810 and abatement action field 1004. The selection of the deleted risks option 106 displays in a scorecard those risks of the project that have been deleted. The selection of executive summary report option 1208 generates and displays a summary of only the critical risks of the project. Finally, the selection of the high, medium and low risks option 1214 generates and displays a bar or pie chart revealing the number of high, medium and low risks for a project. By exporting the information to the spreadsheet file the user can obtain a hardcopy of the information in the report or table.

In addition, the reports and scorecards generated from the reports option 608 can be used for diagnostic functions. The user can review and evaluate the information included in a report or scorecard and then use that information to make determinations on the success or failure of abatements for the risks or to make determinations on an assessment of a risk's impact on the project. In one embodiment, the display of a waterfall chart can be linked with project information in the database to be able to provide the user with additional project information. The user can select a point on the waterfall chart and then be able to obtain additional information from the database that relates to that particular point. For example, a user can retrieve the information from the database that was used in generating the particular point on the waterfall chart. The user can also obtain other information that relates to that particular point for additional analysis capabilities. The availability of this additional information from a point in a waterfall chart can assist a user in making diagnostic determinations on the risks and abatements for a project.

In another embodiment of the present invention, the user has the option to export to a spreadsheet file all of the information from any of the reports generated and displayed from the risk report web page 1200. The user can also export to a spreadsheet file all of the information included in the risk table 902.

In still another embodiment of the present invention, the risk management application can have several different administrative levels that have corresponding levels of privileges. For example, there can be an administrator level, a project owner level and a risk owner level. The administrator level can determine the information fields to be included in the database for the risk management application and has write access to most information in the database. The project owner level can maintain information only for the owner's particular project and has only limited write access to those fields relating to the owner's particular project, while having read only access to the remaining information. Finally, the risk owner level can update and change information on the owner's risks and has read only access to the remaining information.

In yet another embodiment of the present invention, the risk management application has features that assist a user in entering information such as automatic entry of previously entered information and auditing capabilities to check if all required information has been entered by the user.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is

1. A method of managing risks associated with a project, the method comprising the steps of:
defining impact criteria for all risks of a project;
identifying a plurality of risks associated with the project;
storing, in a database, risk information on at least one risk of the plurality of risks;
assessing at least one risk of the plurality of risks using the defined impact criteria;
preparing at least one abatement corresponding to at least one risk of the plurality of risks;
storing, in the database, abatement information on the at least one abatement;
monitoring the plurality of risks associated with the project as the project is completed;
updating the risk information and the abatement information in the database as the project is completed; and
repeating the steps of monitoring the plurality of risks and updating the risk information and the abatement information in the database until each risk of the plurality of risks is indicated as finished.

2. The method of claim 1 wherein the step of monitoring the plurality of risks further comprises a step of automatically generating a report having risk information and abatement information from the database.

3. The method of claim 2 wherein the report is a waterfall chart and the step of monitoring the plurality of risks further comprises a step of providing additional risk information and abatement information from the database in response to a selection of a point on the waterfall chart.

4. The method of claim 1 wherein the step of defining impact criteria further comprises a step of defining impact criteria for at least one issue selected from the group consisting of technical issues, scheduling issues and cost issues.

5. The method of claim 1 wherein the step of assessing at least one risk of the plurality of risks using the defined impact criteria further comprises the steps of:
providing a probability determination for at least one risk;
providing a technical impact determination for at least one risk;
providing a cost impact determination for at least one risk; and
providing a schedule impact determination for at least one risk.

6. The method of claim 1 wherein the step of preparing at least one abatement further comprises the steps of:
providing an estimated probability determination of the at least one abatement corresponding to at least one risk;
providing an estimated technical impact determination of the at least one abatement corresponding to at least one risk;
providing an estimated cost impact determination of the at least one abatement corresponding to at least one risk; and
providing an estimated schedule impact determination of the at least one abatement corresponding to at least one risk.

7. The method of claim 1 wherein the step of updating the risk information and the abatement information comprises the steps of:
providing an actual probability determination of the at least one abatement corresponding to at least one risk based on actual performance of the at least one abatement;
providing an actual technical impact determination of the at least one abatement corresponding to at least one risk based on actual performance of the at least one abatement;
providing an actual cost impact determination of the at least one abatement corresponding to at least one risk based on actual performance of the at least one abatement; and
providing an actual schedule issue impact determination of the at least one abatement corresponding to at least one risk based on actual performance of the at least one abatement.

8. The method of claim 1 wherein the step of monitoring the plurality of risks further comprises the steps of:
displaying risk information from the database in a table; and
displaying abatement information from the database in a table.

9. A computer program product embodied on a computer readable medium and executable by a computer for managing risks associated with a project, the computer program product comprising computer instructions for executing the steps of:
defining impact criteria for all risks of a project;
identifying a plurality of risks associated with the project;
storing, in a database, risk information on at least one risk of the plurality of risks;
assessing at least one risk of the plurality of risks using the defined impact criteria;
preparing at least one abatement corresponding to at least one risk of the plurality of risks;
storing, in the database, abatement information on the at least one abatement;
monitoring the plurality of risks associated with the project as the project is completed;
updating the risk information and the abatement information in the database as the project is completed; and
repeating the steps of monitoring the plurality of risks and updating the risk information and the abatement information in the database until each risk of the plurality of risks is indicated as finished.

10. The computer program product of claim 9 wherein the step of monitoring the plurality of risks further comprises a step of automatically generating a report having risk information and abatement information from the database.

11. The computer program product of claim 10 wherein the report is a waterfall chart and the step of monitoring the plurality of risks further comprises a step of providing additional risk information and abatement information from the database in response to a selection of a point on the waterfall chart.

12. The computer program product of claim 9 wherein the step of defining impact criteria further comprises the steps of:
defining impact criteria for technical issues;
defining impact criteria for scheduling issues; and
defining impact criteria for cost issues.

13. The computer program product of claim 9 wherein the step of assessing at least one risk of the plurality of risks using the defined impact criteria further comprises the steps of:
providing a probability determination for at least one risk;
providing a technical impact determination for at least one risk;
providing a cost impact determination for at least one risk; and
providing a schedule impact determination for at least one risk.

14. The computer program product of claim 9 wherein the stored abatement information comprises:
an estimated probability determination of the at least one abatement corresponding to at least one risk;
an estimated technical impact determination of the at least one abatement corresponding to at least one risk;
an estimated cost impact determination of the at least one abatement corresponding to at least one risk; and
an estimated schedule impact determination of the at least one abatement corresponding to at least one risk.

15. The computer program product of claim 9 wherein the step of updating the risk information and the abatement information comprises:
providing an actual probability determination of the at least one abatement corresponding to at least one risk based on actual performance of the at least one abatement;
providing an actual technical impact determination of the at least one abatement on at least one risk based on actual performance of the at least one abatement;
providing an actual cost impact determination of the at least one abatement corresponding to at least one risk based on actual performance of the at least one abatement; and
providing an actual schedule impact determination of the at least one abatement corresponding to at least one risk based on actual performance of the at least one abatement.

16. The computer program product of claim 9 further comprising computer instructions for executing the steps of:
providing access to the risk information and the abatement information on the project in the database to all users associated with the project; and
permitting all users associated with the project to generate reports having risk information and abatement information from the database.

17. The computer program product of claim 9 wherein the step of updating the risk information and the abatement information further comprises the steps of:
adding an additional risk to the plurality of risks for the project;
adding an additional abatement corresponding to at least one risk of the plurality of risks;
removing a risk from the plurality of risks for the project; and
removing an abatement corresponding to at least one risk of the plurality of risks.

18. A system for analyzing and managing risks associated with a project, the system comprising:
a server computer, said server computer comprising a storage device and a processor;
a risk management application to analyze and manage risks associated with a project, said risk management application being stored in said storage device of said server computer, said risk management application further comprising:
a database, said database storing information relating to said project;
means for providing risk impact criteria for all risks of said project, said risk impact criteria being stored in said database;
means for providing risk information for at least one risk of a plurality of risks, said risk information being stored in said database;
means for providing an assessment of at least one risk of said plurality of risks, said assessment of at least one risk being based said risk impact criteria;
means for calculating a risk score for said assessed at least one risk, said risk score being based on said assessment;
means for providing abatement information corresponding to at least one risk of the plurality of risks, said abatement information being stored in said database;
means for generating a project report, said project report including said risk information and said abatement information stored in said database; and
means for updating said risk information and said abatement information in said database; and
at least one client computer in communication with said server computer, said risk management application being accessible on said at least one client computer.

19. The system of claim 18 wherein said risk management application further comprises:
means for creating a new project, said means for creating a new project comprising means for providing project information, said project information being stored in said database,
means for selecting a project from a plurality of projects;
means for updating said project information stored in said database;
means for displaying a risk summary table, said risk summary table including risk information from said database; and
means for displaying an abatement summary table, said abatement summary table including abatement information from said database.

20. The system of claim 18 wherein:
said at least one client computer is in communication with said server computer over an Intranet;
said risk management application is configured for execution in a web browser;
said risk impact criteria comprises at least one criteria selected from the group consisting of technical impact criteria, schedule impact criteria and cost impact criteria;
said means for providing an assessment comprises means for providing an impact assessment for said risk impact criteria, said impact assessment including a high impact assessment, a medium impact assessment and a low impact assessment; and
said means for updating further comprises:
means for adding risk information to said database on an additional risk to said plurality of risks;
means for adding abatement information to said database on an additional abatement corresponding to at least one risk of said plurality of risks;
means for editing risk information in said database on a risk of said plurality of risks;
means for editing abatement information in said database on an abatement corresponding to at least one risk of said plurality of risks;
means for removing risk information from said database on a risk of said plurality of risks; and
means for removing abatement information from said database on an abatement corresponding to at least one risk of said plurality of risks.
